(19) United States
(12) Patent Application Publication
(10) Pub. No.: US 2023/0033525 A1
(43) Pub. Date: Feb. 2, 2023

(54) POWERED SPRAYER

(71) Applicant: TECHTRONIC CORDLESS GP, Anderson, SC (US)

(72) Inventor: Joseph Suarez, Anderson, SC (US)

(21) Appl. No.: 17/875,590

(22) Filed: Jul. 28, 2022

Related U.S. Application Data
(60) Provisional application No. 63/226,452, filed on Jul. 28, 2021.

(51) Int. Cl. B05B 5/053; B05B 5/035

(52) U.S. Cl. CPC B05B 5/0533; B05B 5/035

(57) ABSTRACT

The present disclosure is directed to a fluid sprayer including a nozzle assembly and a housing that supports the nozzle assembly. The housing includes a handle portion and a forward region that extends between the nozzle assembly and the handle portion. The fluid sprayer also includes a reservoir coupled to the housing and a pump supported within the housing and fluidly connected to the reservoir and to the nozzle assembly. The fluid sprayer further includes an electrostatic charging circuit configured to impart an electrostatic charge in a fluid pumped by the pump, the electrostatic charging circuit including an electrode assembly. The fluid sprayer also includes a grounding element coupled to the housing and extending between a forward portion located in the forward region to a contact portion located adjacent the handle portion.

### CROSS-REFERENCE TO RELATED APPLICATIONS

This application claims priority to co-pending U.S. Provisional Patent Application No. 63/226,452, filed Jul. 28, 2021, the entire content of which is hereby incorporated by reference.

### FIELD OF THE DISCLOSURE

The disclosure relates to fluid delivery devices, and more particularly to portable, battery-powered, electrostatic liquid sprayers.

### BACKGROUND OF THE DISCLOSURE

Powered sprayers, such as foggers, misters, and the like, are commonly used to disperse liquid solutions onto surfaces in vapor, mist or fog form. Some sprayers include electrostatic charging systems to electrostatically charge the spray droplets of the liquid solution, causing the droplets to cling to the targeted surfaces.

### SUMMARY OF THE DISCLOSURE

The present disclosure provides, in one aspect, a fluid sprayer including a nozzle assembly and a housing that supports the nozzle assembly. The housing includes a handle portion and a forward region that extends between the nozzle assembly and the handle portion. The fluid sprayer also includes a reservoir coupled to the housing and a pump supported within the housing and fluidly connected to the reservoir and to the nozzle assembly. The fluid sprayer further includes an electrostatic charging circuit configured to impart an electrostatic charge in a fluid pumped by the pump, the electrostatic charging circuit including an electrode assembly. The fluid sprayer also includes a grounding element coupled to the housing and extending between a forward portion located in the forward region to a contact portion located adjacent the handle portion.

In some constructions, the fluid sprayer further includes a trigger supported in the handle portion. The contact portion of the grounding element is located adjacent the trigger. The electrostatic charging circuit further includes a high voltage wire. An end of the high voltage wire is coupled to the electrode assembly.

The present disclosure provides, in another aspect, a fluid sprayer including a nozzle assembly and a housing that supports the nozzle assembly. The housing includes a handle portion and a forward region that extends between the nozzle assembly and the handle portion. The fluid sprayer also includes a reservoir coupled to the housing, and a pump supported within the housing and fluidly connected to the reservoir and to the nozzle assembly. The fluid sprayer further includes a trigger supported in the handle portion and configured to activate the pump. The fluid sprayer also includes an electrostatic charging circuit configured to impart an electrostatic charge in a fluid pumped by the pump, the electrostatic charging circuit including an electrode assembly. The fluid sprayer further includes a conductive overmold coupled to the housing and extending between a forward portion located adjacent the nozzle assembly and a contact portion located adjacent the trigger.

In some constructions, the electrode assembly comprises a high-voltage electrode assembly including a tube-shaped electrode that contacts the fluid pumped by the pump, and a grounding ring assembly including a ring-shaped electrode supported forward of the nozzle assembly.

Other aspects of the disclosure will become apparent by consideration of the detailed description and accompanying drawings.

### BRIEF DESCRIPTION OF THE DRAWINGS

FIG. 1 is a perspective view of a portable, battery-powered liquid sprayer according to an embodiment of the disclosure.

FIG. 2 is another perspective view of the sprayer of FIG. 1.

FIG. 3 is another perspective view of the sprayer of FIG. 1 with portions removed.

FIG. 4 is a perspective view of an adjustable nozzle assembly of the sprayer of FIG. 1.

FIG. 5 is a schematic view of an electrostatic charging circuit of the sprayer of FIG. 1.

FIG. 6 is an exploded perspective view of a high voltage electrode assembly of the electrostatic charging circuit of FIG. 4.

FIG. 7 is a side view of the sprayer of FIG. 1, illustrating a handle overmold covering a handle portion of a housing.

FIG. 8 is a side view of the sprayer of FIG. 1, illustrating a forward region of the housing.

FIG. 9 is a side view of the sprayer of FIG. 1, illustrating a conductive overmold covering a portion of the housing.

FIG. 10 is an enlarged view illustrating a portion of the conductive overmold of FIG. 9.

Before any embodiments of the disclosure are explained in detail, it is to be understood that the disclosure is not limited in its application to the details of embodiment and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

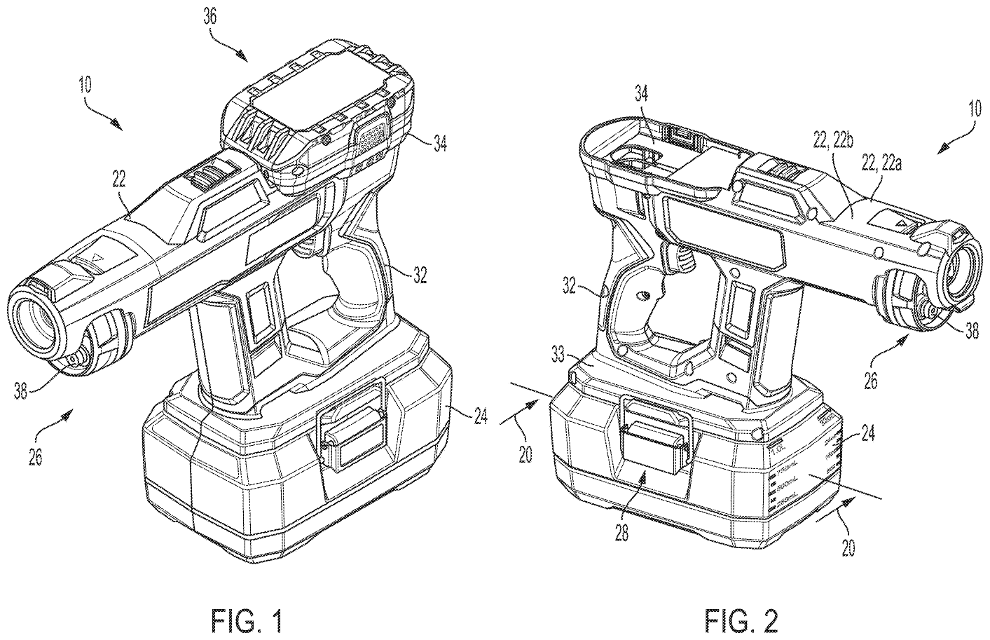

FIGS. 1 and 2 illustrate a portable, battery-powered, electrostatic liquid sprayer 10 according to an embodiment of the present disclosure. The sprayer 10 includes a housing 22, a reservoir 24 to hold a liquid solution (e.g., a disinfecting solution), and a nozzle assembly 26 to dispense the solution as an atomized spray. The housing 22 is formed from a pair of clamshell housing halves 22a, 22b. The reservoir 24 is removably coupled to the housing 22 via latches 28. The housing 22 defines a handle portion 32, a reservoir attachment portion 33 that removably couples to the reservoir 24, and a battery receptacle 34 that selectively couples to a removable and rechargeable battery pack 36 to provide DC electrical power to the sprayer 10. In alternative embodiments, the sprayer 10 may be AC powered (e.g., plugged into a standard home electrical socket), gas-powered (e.g., by one or more internal combustion engines), and the like. The handle portion 32 may be grasped by the user during use to manipulate the orientation and position of the sprayer 10. As will be discussed in further detail below, the nozzle assembly 26 is adjustable to enable switching between different removable nozzles 38 that impart different spray characteristics to the spray (e.g., flow rate, spray pattern, spray droplet size, etc.).

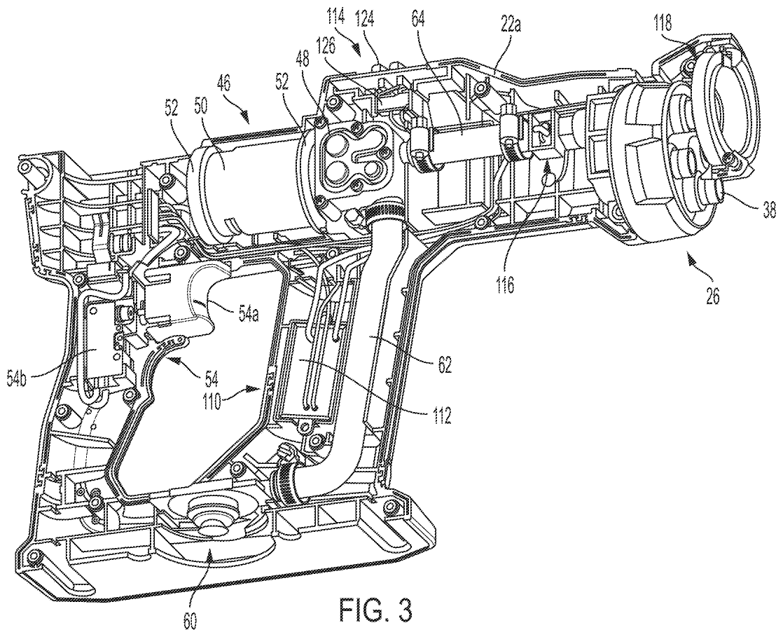

With reference to FIG. 3, the sprayer 10 includes a motor and pump assembly 46 that includes a pump 48 in fluid communication with the reservoir 24 and with the nozzle assembly 26, and a motor 50 configured to drive the pump 48. The motor and pump assembly 46 is supported within the housing 22 by damping elements 52 positioned between the motor and pump assembly 46 and walls of the housing 22 to dampen transmission of vibration therebetween. The handle portion 32 of the housing 22 supports a trigger assembly 54 with a trigger 54a that actuates a trigger switch 54b to selectively activate the motor 50, causing the pump 48 to draw liquid solution from the reservoir 24 and pump the solution toward the nozzle assembly 26 to produce the atomized spray. In the illustrated embodiment, the pump 48 is a diaphragm pump. In other embodiments, other types of pumps may be utilized (e.g., a piston pump, a gear pump, a peristaltic pump, and the like). The sprayer 10 also includes a solution inlet 60 located at the reservoir attachment portion 33 and configured to fluidly connect to the reservoir 24, an inlet conduit 62 fluidly connecting the solution inlet 60 to an inlet side of the pump 48, and an outlet conduit 64 fluidly connected to an outlet side of the pump 48 to direct the liquid solution exiting the pump 48 toward the nozzle assembly 26.

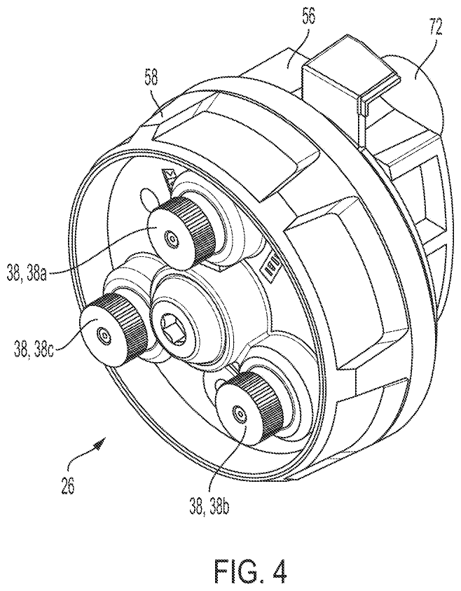

With reference to FIG. 4, the adjustable nozzle assembly 26 includes a nozzle mount 56 fixedly supported by the sprayer housing 22, and a removable and rotatable selection wheel 58 removably coupled to the nozzle mount 56. In the embodiment shown in FIG. 4, the selection wheel 58 supports multiple nozzles 38 including a first nozzle 38a, a second nozzle 38b, and a third nozzle 38c each configured to impart different spray characteristics to the solution sprayed out from the respective nozzle 38a-38c. In the illustrated embodiment, the different nozzles 38a-38c correspond to different droplet sizes of the atomized solution sprayed from the nozzle, including a smallest droplet spray, a medium droplet spray, and a largest droplet spray, respectively. However, the nozzles 38a-38c may be configured to vary other parameters of the spray instead of or in addition to the droplet size, such as the spray pattern, the flow rate, the spray velocity, and the like. Although three nozzles 38 are illustrated, it should be appreciated that the selection wheel 58 may be configured to support fewer than three nozzles (e.g., two nozzles), or more than three nozzles (e.g., four nozzles, five nozzles, etc.) in a manner similar to that described herein.

In operation, the user rotates the selection wheel 58 between first, second, or third positions corresponding to the different nozzles 38a-38c, as desired, and depresses the trigger 54a to activate the motor 50. The motor 50 drives the pump 48 to begin pumping liquid solution from the reservoir 24 toward the adjustable nozzle assembly 26. The solution moving from the pump 48 enters the nozzle mount 56 and sprays outward from the selected nozzle 38a-38c. To select a different nozzle 38a-38c, the user releases the trigger 54a, rotates the selection wheel 58 to another of the first, second, or third positions as desired.

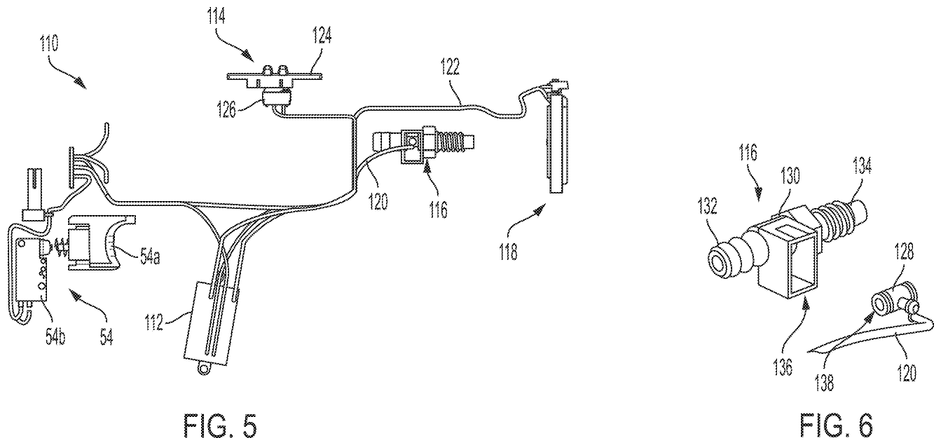

With reference to FIGS. 3 and 5, the sprayer 10 also includes an electrostatic charging circuit 110 operable to impart an electrostatic charge in the atomized liquid droplets exiting the nozzle assembly 26 during operation of the sprayer 10. The electrostatic charging circuit 110 includes a high voltage supply module 112 supported within the housing 22, a charging on/off switch assembly 114, a first or high voltage electrode assembly 116, and a second electrode assembly or grounding ring assembly 118. The high voltage supply module 112 receives power from the battery pack 36 and supplies power, via a high voltage wire 120, to the high voltage electrode assembly 116. The grounding ring assembly 118 is electrically coupled to the high voltage supply module 112 via a grounding wire 122 to complete the charging circuit 110.

The charging on/off switch assembly 114 includes a slider 124 movable between on and off positions to actuate a charging on/off switch 126. In the illustrated embodiment of the sprayer 10, the motor 50 is electrically connected to an output terminal of the trigger switch 54b, so that when the trigger 54a is actuated, the motor 50 is activated to begin pumping the liquid solution toward the nozzle assembly 26. The charging on/off switch 126 is located between the output terminal of the trigger switch 54b and the high voltage supply module 112. Accordingly, when the trigger 54a is released such that the trigger switch 54b is open, the charging circuit 110 is necessarily deactivated. When the trigger 54a is pulled to close the trigger switch 54b, the electrostatic charging circuit 110 can then be toggled on or off via actuation of the charging on/off switch assembly 114. The sprayer 10 can thus be operated with the electrostatic charging circuit 110 enabled or disabled as desired by the user by moving the slider 124 of the charging on/off switch assembly 114 between the on and off positions. It should be understood that in other embodiments of the sprayer 10 (not shown), the charging on/off switch assembly 114 may be omitted, so that actuation of the trigger switch 54b activates both the motor 50 and the electrostatic charging circuit 110.

With reference to FIG. 6, the high voltage electrode assembly 116 includes a high voltage electrode 128 and an electrode housing 130 with an electrode housing inlet 132, an electrode housing outlet 134, and an electrode receptacle 136. In the illustrated embodiment, the electrode housing inlet 132 couples to the outlet conduit 64 to receive liquid solution from the pump 48, and the electrode housing outlet 134 couples to an inlet 72 of the nozzle mount 56. In other embodiments (not shown), the high voltage electrode assembly 116 can be located at other points along a continuous flow path between the reservoir 24 and the nozzle assembly 26, including, e.g., upstream from the pump 48. In the illustrated embodiment, the high voltage electrode 128 is provided as a conductive tube formed from a conductive material such as, e.g., copper, brass, or the like. The high voltage electrode 128 is held and sealed within the electrode receptacle 136 by potting (not shown), and defines a central passageway 138 through which the liquid solution flows between the electrode housing inlet and outlet 132, 134. During operation of the sprayer 10, the liquid solution thus passes through the central passageway 138 of the high voltage electrode 128 such that the liquid solution is directly charged by direct contact with the high voltage electrode 128.

As shown in FIG. 3, the grounding ring assembly 118 is supported by the housing 22 at a location forward of the nozzle assembly 26 and centered about the spray nozzle 38. When the charging circuit 110 is active, an electric field develops between the grounding ring assembly 118 and any conductive material (such as, e.g., the liquid solution) in electrical contact with the high voltage electrode 128. As the atomized spray droplets of the liquid solution exit the spray nozzle 38, the droplets pass through the interior of the grounding ring assembly 118 and through the electric field, thereby acquiring an electrostatic charge. The acquired charge enables the spray droplets to better adhere or “stick” to targeted surfaces.

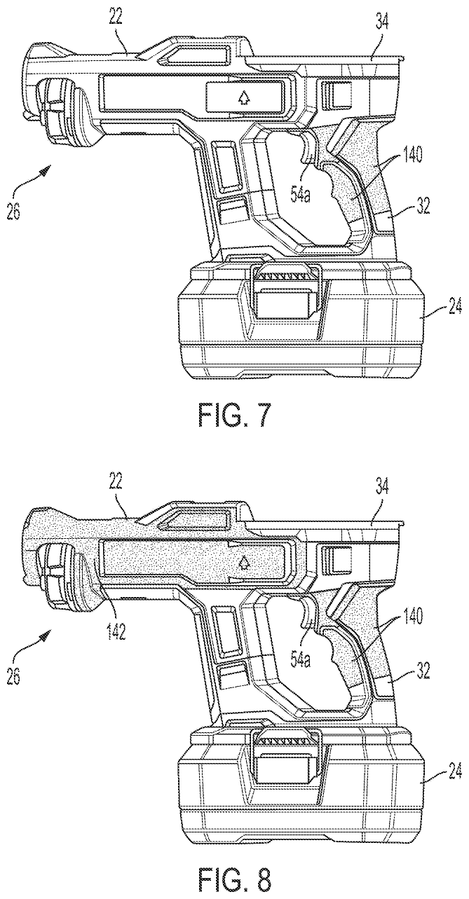

In some embodiments, a static charge can build up on the housing 22 and can reach upwards of 20 kilovolts (kV) if not allowed to dissipate to ground. The buildup of static charge can weaken or prevent the electrostatic charging of the atomized spray droplets during operation of the sprayer 10. With reference to FIG. 7, the sprayer 10 includes a handle overmold 140 covering the handle portion 32. In some embodiments, the handle overmold 140 is formed from a relatively highly insulative material (e.g., rubber, silicone, and the like). When the user grasps the handle portion 32 during operation, the handle overmold 140 may not be sufficiently conductive to allow the charge built up on the housing 22 to dissipate to ground (via the user's hand) fast enough to prevent the accumulated static charge from weakening the electrostatic charging of the spray.

FIG. 8 illustrates a forward region 142 of the housing 22 that extends between the nozzle assembly 26 and the handle portion 32. The forward region 142 is not covered by the handle overmold 140. As such, the forward region 142 is relatively more conductive than the handle portion 32. In addition, during operation of the sprayer 10, moisture from the charged spray emitted from the nozzle assembly 26 can accumulate on the forward region 142 and increase the conductivity of the forward region 142 of the housing 22.

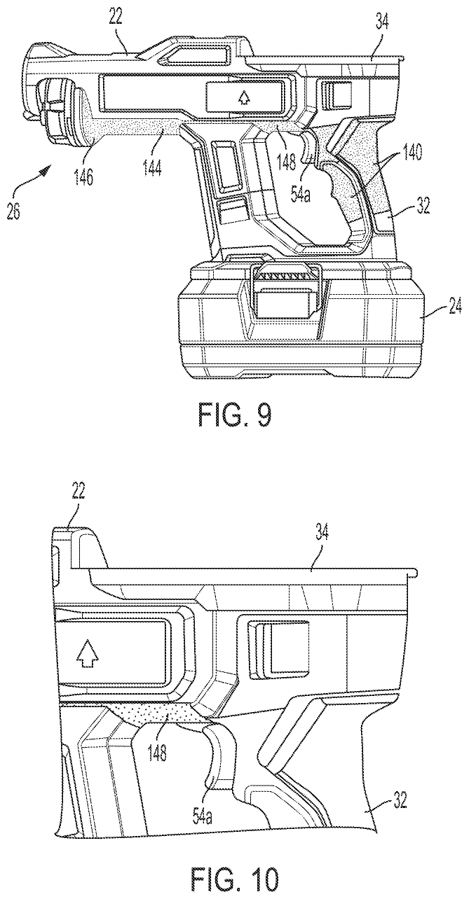

FIGS. 9 and 10 illustrate an embodiment of the electrostatic sprayer 10 that includes a grounding element 144 to ground to the user's hand when the user is grasping the handle portion 32. In the illustrated embodiment, the grounding element 144 is provided as a conductive overmold 144 attached to the housing 22 and extending from the forward region 142 of the housing 22 (where the high voltage electrode assembly 116 and the grounding ring assembly 118 are generally located) toward the handle portion 32. The conductive overmold 144 extends uninterrupted between a forward portion 146 located proximate the nozzle assembly 26 and a contact portion 148 positioned proximate the trigger 54a. The contact portion 148 is positioned sufficiently close to the trigger 54a to contact the user's hand during actuation of the trigger 54a. The conductive overmold 144 provides a conductive pathway between the forward region 142 (FIG. 8) of the housing 22 and the user's hand when grasping the handle portion 32. This allows any static charge building in the housing 22 during operation of the sprayer 10 to dissipate sufficiently quickly to ground via the user's hand, thus preventing any buildup of static charge from weakening the electrostatic charging of the atomized spray droplets. The conductive overmold 144 does not include any electrical connections to any of the sprayer electrical circuits (e.g., such as the electrostatic charging circuit 110). Instead, the conductive overmold 144 only contacts the housing 22 of the sprayer 10.

In the illustrated embodiment, the conductive overmold 144 can be provided as an overmolded conductive material. The conductive material can include, e.g., a filler (such as carbon black) or pigment added to a rubber, composite material formula, or the like. The filler increases the electrical conductivity of the overmolded material. In other embodiments (not shown), the grounding element can alternatively be provided as an elongated conductive member having the same general shape as the conductive overmold 144 and similarly coupled to the housing 22, but formed from another conductive material (e.g., metal, conductive plastic, etc.) In the illustrated embodiments, the handle overmold 140 has a greater electrical resistivity than the conductive overmold 144. In addition, the housing 22 is formed from a material having a greater electrical resistivity than the conductive overmold 144.

Various features of the disclosure are set forth in the following claims.

What is claimed is:

1. A fluid sprayer comprising:
a nozzle assembly;
a housing that supports the nozzle assembly, the housing including a handle portion and a forward region that extends between the nozzle assembly and the handle portion;
a reservoir coupled to the housing;
a pump supported within the housing and fluidly connected to the reservoir and to the nozzle assembly;
an electrostatic charging circuit configured to impart an electrostatic charge in a fluid pumped by the pump, the electrostatic charging circuit including an electrode assembly; and
a grounding element coupled to the housing and extending between a forward portion located in the forward region to a contact portion located adjacent the handle portion.

2. The fluid sprayer of claim 1, further comprising a trigger supported in the handle portion, wherein the contact portion of the grounding element is located adjacent the trigger.

3. The fluid sprayer of claim 1, wherein the electrostatic charging circuit further includes a high voltage wire, and wherein an end of the high voltage wire is coupled to the electrode assembly.

4. The fluid sprayer of claim 1, wherein the grounding element is formed at least partially from a conductive overmold that includes a conductive filler.

5. The fluid sprayer of claim 1, wherein the contact portion of the grounding element is positioned to contact a hand of a user when the user is grasping the handle portion.

6. The fluid sprayer of claim 1, wherein the nozzle assembly includes a rotatable selection wheel that supports a first nozzle and a second nozzle, and wherein the forward portion of the grounding element is located adjacent the selection wheel.

7. The fluid sprayer of claim 1, further comprising a handle overmold coupled to the handle portion and formed separately from the grounding element.

8. The fluid sprayer of claim 7, wherein the handle overmold has a greater electrical resistivity than the grounding element.

9. The fluid sprayer of claim 1, wherein the grounding element is formed from at least one of a metal and a conductive plastic.

10. The fluid sprayer of claim 1, wherein the grounding element comprises a conductive overmold formed from a composite material.

11. A fluid sprayer comprising:
a nozzle assembly;
a housing that supports the nozzle assembly, the housing including a handle portion and a forward region that extends between the nozzle assembly and the handle portion;
a reservoir coupled to the housing;
a pump supported within the housing and fluidly connected to the reservoir and to the nozzle assembly;
a trigger supported in the handle portion and configured to activate the pump;
an electrostatic charging circuit configured to impart an electrostatic charge in a fluid pumped by the pump, the electrostatic charging circuit including an electrode assembly; and
a conductive overmold coupled to the housing and extending between a forward portion located adjacent the nozzle assembly and a contact portion located adjacent the trigger.

12. The fluid sprayer of claim 11, wherein the electrode assembly comprises a high-voltage electrode assembly including a conductive tube that contacts a spray liquid pumped by the pump, and a grounding ring assembly including a ring-shaped electrode supported forward of the nozzle assembly.

13. The fluid sprayer of claim 12, wherein the high-voltage electrode assembly is electrically coupled to a high voltage wire and the grounding ring assembly is coupled to a grounding wire.

14. The fluid sprayer of claim 11, wherein the nozzle assembly includes a rotatable selection wheel that supports a first nozzle and a second nozzle, and wherein the forward portion of the conductive overmold is located adjacent the selection wheel.

15. The fluid sprayer of claim 11, further comprising a handle overmold coupled to the handle portion and formed separately from the conductive overmold.

16. The fluid sprayer of claim 15, wherein the handle overmold has a greater electrical resistivity than the conductive overmold.

17. The fluid sprayer of claim 11, wherein the housing is formed from a material having a greater electrical resistivity than the conductive overmold.

18. The fluid sprayer of claim 11, wherein the contact portion of the conductive overmold is positioned to contact a hand of a user when the user is grasping the handle portion.

19. The fluid sprayer of claim 11, wherein the housing defines a battery receptacle configured to selectively couple to a battery pack.

20. The fluid sprayer of claim 19, wherein the housing defines a reservoir attachment portion configured to selectively couple to a reservoir.
